(19) United States
(12) Patent Application Publication
(10) Pub. No.: US 2026/0195523 A1
(43) Pub. Date: Jul. 9, 2026

(54) HIERARCHICAL CONTENT GENERATION

(71) Applicant: Dell Products L.P., Round Rock, TX (US)

(72) Inventors: Pablo Nascimento da Silva, Niterói (BR); Paulo Abelha Ferreira, Rio de Janeiro (BR); Iam Palatnik de Sousa, Rio de Janeiro (BR); Douglas Diniz Landim, São Paulo (BR)

(21) Appl. No.: 19/010,814

(22) Filed: Jan. 6, 2025

(51) Int. Cl. G06F 40/166; G06F 16/334

(52) U.S. Cl. CPC G06F 40/166; G06F 16/334

(57) ABSTRACT

Content generation is disclosed. Sources for generating content are provided along with a query to a content generation system. The system generates an outline based on a set of sources that is based on the initial query. Sections of the outline are filled by generating text. Text for each section are generated by reranking the set of sources for each of the sections based on section titles. An initial draft of the content is presented and modifications are performed. The modifications may include regenerating text of selected sections using a query. When modifications are completed, a final content is generated.

### TECHNOLOGICAL FIELD OF THE DISCLOSURE

Embodiments disclosed herein generally relate to content generation. More particularly, at least some embodiments relate to systems, hardware, software, computer-readable media, and methods for hierarchical and guided content generation.

### BACKGROUND

Content generation is a core element of generative artificial intelligence (GenAI). While GenAI models are able to generate various types of content, the ability to generate content having a particular style is a more difficult challenge. For example, the manner in which text is generated (e.g., predicted) by conventional GenAI presents challenges when attempting to control the output of these models at least because text is often generated or predicted token by token. Predicting text token by token makes controlling the style of the output difficult to control.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1A discloses aspects of generating content such as text in a particular style;

FIG. 1B discloses additional aspects of generating content such as text;

FIG. 2 discloses further aspects of generating content such as text;

FIG. 3 discloses additional aspects of generating content such as text;

FIG. 4 discloses aspects of a user interface for generating and/or regenerating content such as text; and

FIG. 5 discloses aspects of a computing device, a computing system, or a computing entity.

### DETAILED DESCRIPTION OF SOME EXAMPLE EMBODIMENTS

Embodiments disclosed herein generally relate to content generation using generative artificial intelligence (GenAI). More particularly, at least some embodiments relate to systems, hardware, software, computer-readable media, and methods for style-specific content generation. More specifically, embodiments of the invention relate to retrieval augmented generation (RAG)-based hierarchical content generation.

Generating content is a core aspect of GenAI and various types of content can be generated using GenAI. Embodiments of the invention relate to generating content in a specific style. Style may refer, by way of example only and not limitation, to a format, to user-subjective content, outline-based content, or the like. Embodiments of the invention are discussed in the context of generating text and is more specifically discussed in the context of generating a document (e.g., a blog post). Embodiments of the invention are discussed in the context of GenAI applications or systems configured to generate text such as a blog, but may also apply to GenAI applications or systems configured to generate text, images, sound, video, or the like or combinations thereof.

In one example, embodiments of the invention relate to generating a document that includes text. Generating the text of the document may include iterative aspects. For example, a content generation system may generate an initial draft of a document based on a user query. If the document is not suitable (e.g., from a user’s subjective viewpoint or from a desired style perspective), the text or portions of the document may be regenerated. Regenerating the text of the document or portions of the document, in one example, may be an iterative process in which a user interacts with the content generation system to (re)generate/refine the draft of the document. The process of generating the text of the document may terminate when the user is satisfied with the generated text. Embodiments of the invention, by way of example only, advantageously improve the efficiency of marketing applications, educational applications, enterprise-internal applications, and the like or combinations thereof at least because the text can be generated more quickly.

For example, an entity may communicate developments or other information using blogs or other communication mediums. Blogs are often used to announce new products, provide information about upcoming events such as product release dates, notify users of potential issues, provide service and support announcements, and the like. The process of manually creating the blog from scratch, however, requires time.

Embodiments of the invention relate to a content generation system that includes or has access to models (e.g., large language models (LLMs) and/or smaller models) configured to generate text based on user input (e.g., queries). The draft of the document generated by the content generation system can be accepted as-is, partially or wholly regenerated, or the like or combinations thereof.

Embodiments of the invention further relate to combining GenAI models with heuristics, such as external self-reflection heuristics. Harnessing the strong linguistic capabilities of language models, including LLMs, with rules-of-thumb and heuristics allow for better control of the model’s output.

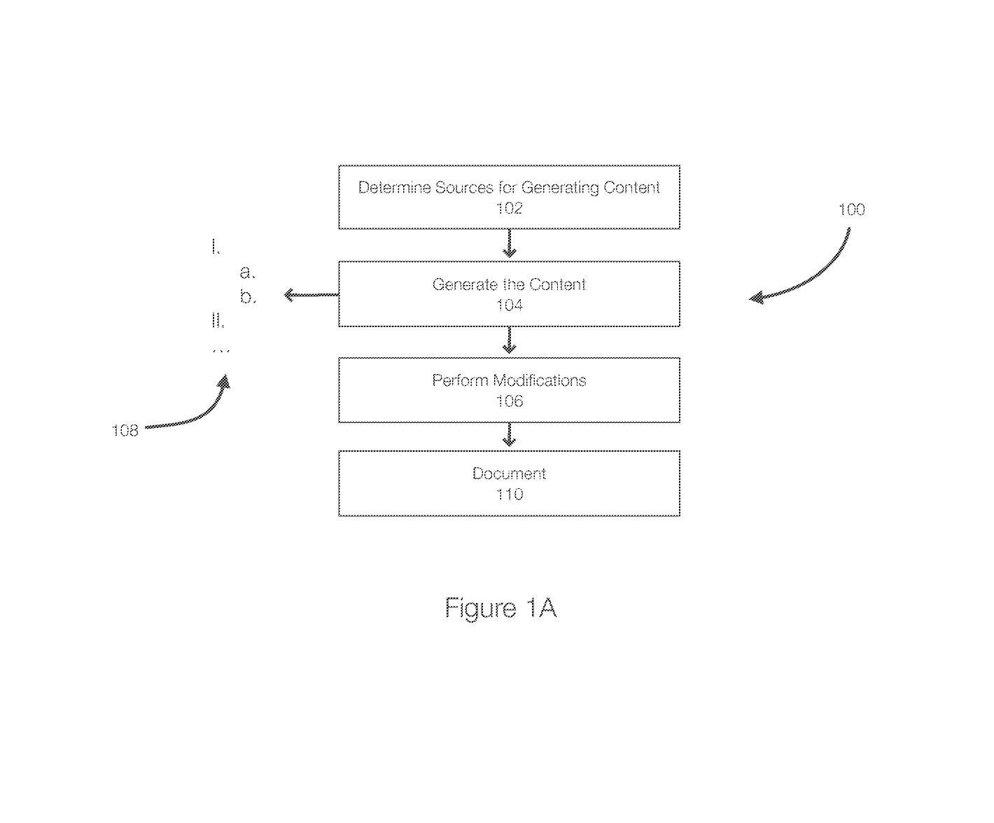

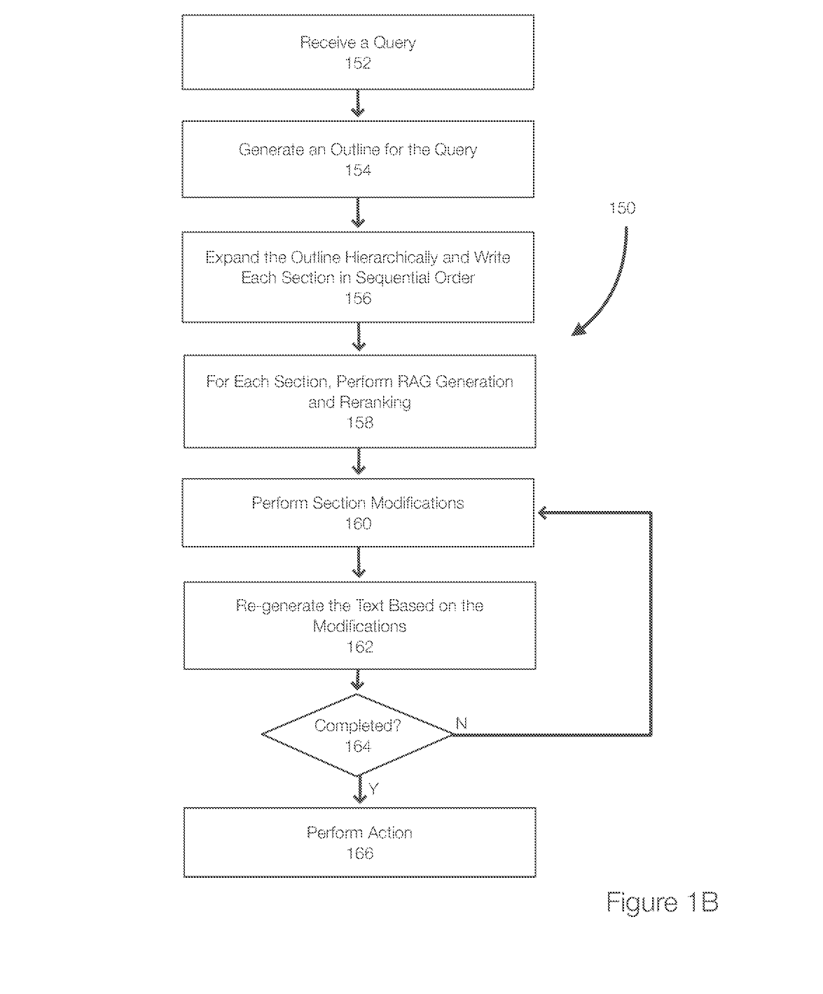

FIG. 1A generally discloses aspects of generating content such as a document. In the method 100, sources for generating a document are determined or identified. Determining the sources to be used to generate text may include sourcing content for use by the content generation system. Sourcing content includes, by way of example, online sourcing and offline sourcing.

Online sourcing allows a user to send/provide (e.g., by uploading) their own sources (e.g., source documents) to the content generation system. The online sources, which may be uploaded in various formats (pdf, word processing, text, image, links) are referred to as online sources because, in one embodiment, the online sources are only known by the content generation system during user interactions. The online sources may be added to a content generation system as RAG-based sources. This allows the content generation system to use the online sources even though the online sources were not used for training purposes in one example.

The online sources are converted to text if necessary and are processed by the content generation system. Processing the online sources, after extracting text if necessary, includes chunking the text (i.e., partitioning the text into smaller pieces). Chunking the text allows the text to be embedded or represented as a vector and compared semantically to other embeddings (e.g., query embeddings).

Offline sourcing relates to all sources used during the process of generating content that are known by or available to the content generation system. Offline sources may include sources used to train the content generation system (e.g., train the LLM) and/or other external knowledge base(s) (e.g., RAG-based sources). Each external knowledge base includes or is associated with a vector database. Specific documents or sources in the knowledge bases can be identified by comparing a query embedding with embeddings of the sources in the vector database. In one example, the online and offline sources may be combined into a single set of sources. This allows the content generation system to select specific sources (e.g., specific documents) or portions thereof (e.g., chunks) that are closest to the query embedding.

More specifically, when a query is received, the query is processed (e.g., embedded and compared to other embeddings) using a RAG-based system in one example, to retrieve the k closest chunks or documents from the online and/or offline sources. Thus, the sources (e.g., documents or portions thereof) deemed most relevant to a particular query may include online sources and/or offline sources. In one example, the format for the online and offline sources may be similar or the same such that the content generation system can generate content such as a document using the most relevant (e.g., closest to the query) sources, which may come from one or both of the online and offline sources.

After sources for generating the content have been determined 102, the method 100 also generates 102 the content. In one example, the content is generated in stages. The stages may include generating an outline that includes sections and then generating the text for each of the sections in the outline. More specifically, when generating the outline, the content generation system receives a query, online sources, and/or other parameters (e.g., voice, tone, type of content) as input. This input allows the content generation system to generate an outline that includes sections.

More specifically, the input may be used to build a prompt, which may also be configured or designed to follow a template such as “Section Title:<title>\nSection Description:<description>”. The template may have similar entries for other sections. Thus, when the prompt is input to the content generation system, the result is an outline that can be easily divided into sections or that is already represented as sections. Each section may have a title and a description.

The sections can be hierarchically expanded and text for each of the sections is generated by the content generation system the online and/or offline sources. More specifically, once the outline has been generated, the section titles and descriptions are hierarchically extracted from the outline and incorporated into a prompt for generating the corresponding text. For example, an outline may have a structure such as illustrated by the outline structure 108.

When expanding the outline hierarchically, the sections (e.g., I., I.a., I.b., II., …) may be generated sequentially and/or independently. In either case, each section is written/generated independently of the other sections.

More specifically, the content generation system may include a reranking model. In one example, when the outline is generated, a set of sources may be identified. This set of sources may also be used for generating each of the sections.

However, the set of sources is reranked for each section. More specifically, the sources used for generating the outline are provided to a reranking model and compared with the relevant section title. The reranking model may compare embeddings of the title with embeddings of the sources. This allows the nearest sources from the set of sources to each title to be determined. For each section begin generated, each source receives a new relevant score based, in one example, on the corresponding section title. Based on these new scores, the sources are reranked and used to generate the description or text of each section in the outline. Thus, the most relevant sources for one section may be different from the most relevant sources of another section. The text generated for each of the sections can be combined to generate an initial draft or current draft of the document being generated by the content generation system.

In some examples, information from a previous section may be used to help the content generation system generate the next section. When generating the sections in a hierarchical manner, the previous sections that have already been generated are available for generating subsequent sections in the hierarchy. This improves continuity in the writing or generation process. For instance, a previous section may be included in a prompt for a next section being generated. In one example, aspects or operations discussed herein can be executed in parallel or sequentially, sources can be reranked at the same time for each of the sections, descriptions can be improved (regenerated) at the same time and the final document, which includes the text of all sections or parts, can be generated in parallel.

Generating content includes writing special parts of the document. Special parts may include, by way of example only, the title, an excerpt, a summary, and/or a conclusion. These special parts may include or be associated with prompts that are configured accordingly. In one example, the excerpt and summary are generated from the text of all of the sections in one example. The title can be generated using the sections and/or the summary. Thus, the special parts may be generated from the generated document rather than the sources in one example.

Once a draft document is generated (which may be an initial draft of the document or an intermediate draft of the document), modifications may be performed 106. Performing 106 modifications includes allowing users to interact with the generated text and select parts (e.g., sections) for modification. The parts selected for modification may or may not coincide with the sections. For instance, a user may highlight a portion of the document to be regenerated or manually make an edit in the document.

In one example, because the document is composed of sections of a structured outline, the parts selected for regeneration can be mapped to the outline’s sections. This allows the sources used for a specific section to be used again as needed when regenerating a selected part of the text. In another example, users may be limited to regenerating sections only. In both cases, the section or portion thereof will be regenerated by submitting a new user query, which may result in a different set of sources and/or a different ranking of the sources.

In one example, each section, including the special parts, of the text is generated separately. A dictionary (e.g., key-value) can be built where the key is the part/section of the text (e.g., Title, Summary, Excerpt or the section title) and the value is the generated text for that specific part/section. This allows any part or section to be re-generated (edited) individually.

To regenerate a section or a part, a user may select a part of the draft document or a section of the draft document and provide a new query. The system regenerates the content using the selected section or portion, the new query and the sources associated with the selected section or portion. As previously stated, regenerating the text may include embedding the new query such that the sources can be reranked if necessary.

Examples of user queries may include a query to regenerate the section in a different tone, a different language, removing mentions to some topic or product or including mentions to some topic or product, among others. The new query may also include additional text to consider. The sources used to generate the document are stored, at least temporarily, such that the content can be reused during the modification operations. Specialized prompts may be predefined for different editing types (adding mentions, removing mentions). The content of the query may determine whether embeddings and/or reranking is required.

More specifically, embodiments of the invention relate to a hierarchical-expansion self-reflection heuristic combined with a per-section reranking model that allow a user to specify (i) a number of sections in a document, such as a blog post, and (ii) specify which sections are mandatory (e.g. title, summary, conclusion) and which sections have optional numbers/titles (e.g. middle sections). Embodiments of the invention may also provide constrained decoding for guiding the model when generating the output.

After the model generates an initial draft the document, the text of the document can be interactively refined by (i) manually editing the content of the document and/or (ii) performing guided regeneration of specific sections or parts of the document. In one example, editing may include selecting specific sections or parts (which may include overlapping sections) for regeneration. The selected sections or portions may be submitted to the content generation system, along with a new query, and regenerated.

The content generation system may use a draft model (e.g., an LLM) to generate an initial draft of the document and another model (e.g., an LLM) to regenerate selected sections or parts. The model that generates the initial draft of the document may be the same as the model that performs the regeneration operations. In one example, the model that regenerates the selected sections or parts of the document may be specialized in making small ‘fill-in-the-middle’ (FIM) type corrections, where the model can see both the text before and after the insertion point or the section/part being modified.

Embodiments of the invention may, more specifically, generate content using RAG. RAG-based systems, in accordance with embodiments of the invention, include a ranking mechanism. Thus, the sources used for each section of the content can be selected or prioritized for each section individually. In addition, the sources used for each section can be tracked and used during regeneration operations. When the modifications are completed or the user is satisfied, the final document 110 is generated. If the document 110 is a blog, the blog may be posted.

Embodiments of the invention thus relate to generating content such as text (or a document) with a hierarchical self-reflection heuristic, section-wise source reranking, and/or constrained decoding. Hierarchical expansion is a self-reflection heuristic, or in simpler terms, a rule-of-thumb for text generation with an LLM. Text generation in this heuristic may include various operations. In one example, the heuristic includes (i) generating an outline of the text, with mandatory and/or optional sections, (ii) parsing the outline into a hierarchical tree-like structure, and (iii) presenting each section and subsection of this tree sequentially to the content generation system such that the content generation system can expand (generate) each section one by one. These steps may be performed automatically.

By way of example only, mandatory sections of an outline may include a title section, an abstract section, a highlight section (e.g., an excerpt), and a conclusion section. Optional sections of the outline may have arbitrary titles selected by a user or generated by the LLM. The number of optional sections can be controlled by truncating a list of candidate sections generated by the model in the outline generation step. The outline is expanded sequentially in one example in a hierarchical manner and the mandatory sections may be located at desired locations of the content being generated (e.g., a mandatory conclusion section may be placed at the end of the text). The result is a document (or other content) content that follows the structure or style of the outline or of the user. In this sense, text or content is generated in a manner that is based on a particular style.

In one example, the sources have been divided into chunks. Thus, chunks may be retrieved by a RAG-based system. However, it may be possible to retrieve documents (e.g., retrieve each document related the set of chunks). For example, a RAG-based system may retrieve a set of chunks based on a user query in conjunction with online and/or offline sources. This set of chunks may be ranked according to a similarity score in the context of the initial query. When the individual sections are generated, the same set of chunks are reranked based on a new query (e.g., the title of the corresponding section). Because the title of a section is likely different from the initial query used to generate the outline, the set of chunks initially retrieved are reranked based on the corresponding title. This helps ensure that each section is generated from chunks (or documents or sources) that are most relevant to the section (e.g., sources that are most similar to the section titles).

Embodiments of the invention may also include constrained generation as an additional level of control. Constrained generation causes an LLM to obey certain constraints at the token prediction level. Example constraints include length of sentences in tokens/characters, usage or avoidance of specific word choices, formatting, regex (regular expression) generation, and the like or combinations thereof.

In one example, when content is generated in a RAG-based system, retrieving sources may include, by way of example, a fast search (whether lexical, semantic or hybrid in nature) with lightweight models or techniques to retrieve a large number of potentially good candidate sources. In one example, a lightweight model is configured to be more efficient in terms of size, speed and/or computational requirements. Thus, a model that is smaller, faster, requires fewer computing resources, has fewer parameters or the like is lightweight compared to another model that may have comparatively larger requirements. The results of the fast search are input to a reranking model (e.g., an LLM fine-tuned for the task of reranking). In other words, with a given set of candidate sources, the reranking model is tasked to find or identify those sources that are most related to a given text using the reranking model’s full set of weights and all-to-all attention matrices, unlike the light-weight models that may be employed in the fast search. The task performed by the reranking model is a more expensive task. As a result, this task is typically performed using a subset of candidate sources (e.g., the top k sources) of the sources identified by the fast search.

In one example embodiment, the reranking model is called, for each section, on a small set of N best possible sources. The reranking model may be called in parallel for each section and/or subsection. Further, the sources for each section or subsection may differ at least because the rankings may depend on the corresponding title (or other input/query), which may be different for each of the sections being generated.

FIG. 1B discloses aspects of generating content such as text of a document in a particular style. As previously stated, embodiments of the invention may be directed to generating text of a document such as a blog. In one example, generating a document may be initiated by a single query. After the initial query is received, an initial draft of the document is generated and the draft of the document may be iteratively and/or interactively refined or developed based on manual edits and/or additional querying. The process of making modifications may be performed repeatedly until the generated document is satisfactory.

In one example, the LLM (or other model) that generates the initial draft of the document and the LLM (or other model or FIM model) that performs section regeneration (e.g., section modifications) may be different at least because the task of generating text for an initial draft and infilling (editing/regenerating specific sections of the document) are different. These two models, however, may be the same model.

The method 150 includes receiving 152 a query at a content generation system that includes a draft model (model configured to generate an outline and initial draft of the document), such as an LLM. The query may be received from a user via a user interface. The query may be accompanied with online sources. Prior to executing the query, the online sources are processed as previously described such that sources responsive or relevant to the query can be identified.

Once the online sources are ready (e.g., chunked and embedded as vectors), a prompt may be constructed. The prompt that is generated in response to the query may include instructions such that the response is an outline that includes one or more sections. In other words, the draft model may generate 154 an outline for the query, sources, and other instructions or constraints reflected in the prompt. Generating the outline may include identifying a set of sources from the online and/or offline sources and generating the outline using the set of sources or portions thereof. The outline is then expanded hierarchically and each section of the text is generated 156 sequentially by the draft model in one example. For each section, the model may perform 158 RAG reranking and RAG generation when writing/generating the sections. In other words, the set of sources previously retrieved are reranked based, in one example, on a section’s title and the text for that section is then generated using the k top reranked sources. Once all of the sections are generated, the sections are combined and the overall document, which includes the text of all sections and/or special parts, may be presented to a user in a user interface.

Next, the method 150 performs 160 section modifications. Section modifications may include receiving input from a user to edit the text of a section manually or asking (e.g., inputting a query) the draft model (or a different modification model) to regenerate one or more sections of text. Thus, the selected sections are regenerated 162 based on the modifications and/or queries. Once the selected sections are regenerated, another draft of the document may be presented to the user.

If the user is satisfied with the current draft of the document (Y at 164), the document is completed and an action may be performed 166. An example action is to post the generated text as a blog entry. If the user is not satisfied (N at 164), the method 150 may loop and perform 160 modifications to sections of the text and regenerate 162 the text. The method 150 may end when the action is performed 166 or the user is satisfied with the text of the sections or, more generally, the generated document.

Embodiments of the invention advantageously generate text (or other content) in a manner that is controlled using specific criteria and/or outlines. This facilitates better reproducibility and predictability compared to simply asking an LLM to generate a longer form document. Sources may be reranked on a per section basis and text regenerations can be performed in a parallel manner.

Performing a reranking operation with respect to each section improves the relevance of the documents or sources used in generating the text of the various sections while also allowing the sources to be tracked on a per section basis. This improves the user experience in generating or creating the document.

If the modifications include manual modifications, changes may be input via a user interface. Alternatively, sections to be regenerated can be selected via the interface and submitted to a modification model along with a query to guide the regeneration of the section. By submitting a query, the sources can be updated, reranked, or the like based on the new section specific query.

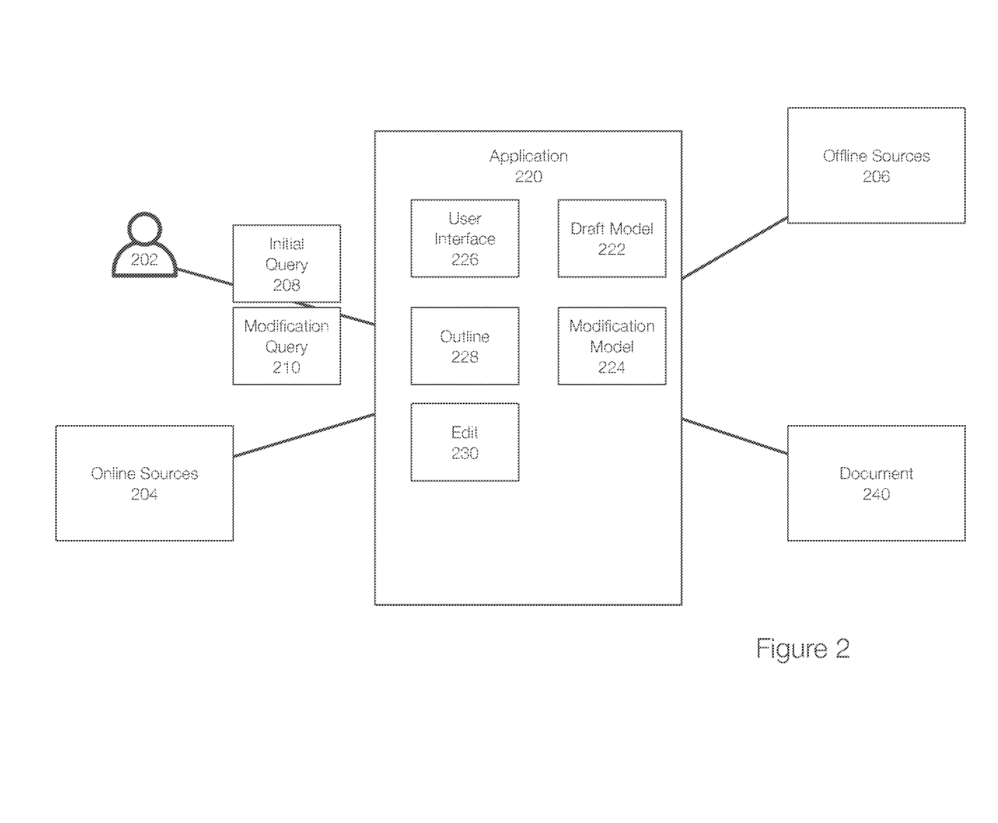

FIG. 2 discloses further aspects of generating text. FIG. 2 illustrates an application 220 (or system), which is an example of a content generation application/system. The application 220 includes or has access to a draft model 222 and a modification model 224, which may be the same model. In one example, the draft model 222 is an LLM that is employed to generate an initial draft (or outline) of a document (e.g., a blog). In one example, the modification model 224 is an LLM that is configured or tuned as an FIM model and configured for infilling or regenerating text. The draft model 222 and the modification model 224 may be RAG-based systems that may have access to an external knowledge base, such as the online sources 204.

The application 220 more generally is to generate text in response to an initial query 208 via a user interface 226 by a user 202. The user 202 may also provide online sources 204 with the initial query 208. The online sources 204 and/or the offline sources 206 are used by the draft model 222 to generate an initial draft of a document 240. More specifically, the application 220, in response to the query 226, which includes the online sources 204, may input the query 208 to the draft model 222, which may generate a response (i.e., the initial draft or outline). The draft model 222, which may be a RAG-based system, may also have access to offline sources 206 and may draw from the offline sources 206 when generating the initial draft in addition to the online sources 204. However, the initial draft may be limited to the online sources 204 in some examples. If online sources 204 are not provided, the draft model 222 may use the offline sources 206.

The process of generating the document 240 may include generating an outline 228. In one example, the initial response of the draft model 222 may be an outline, such as the outline 228. The outline 228 is used by the application 220 to generate an initial draft of the document 240 by generating text for each of the sections in the outline 228. The user 202, via the user interface, may perform modifications to the draft of the document 240 using an editing component 230 of the user interface 226. Editing the sections of the draft document may include making changes manually and/or using the modification model 224 to regenerate selected sections. In one example, sections may be selected and, together with a modification query 210, provided as input to the modification model 224. Once the relevant or selected sections are regenerated, another draft of the document may be presented to the user 202 via the user interface 226. This many continue until the document 240 is completed and no further modifications are performed.

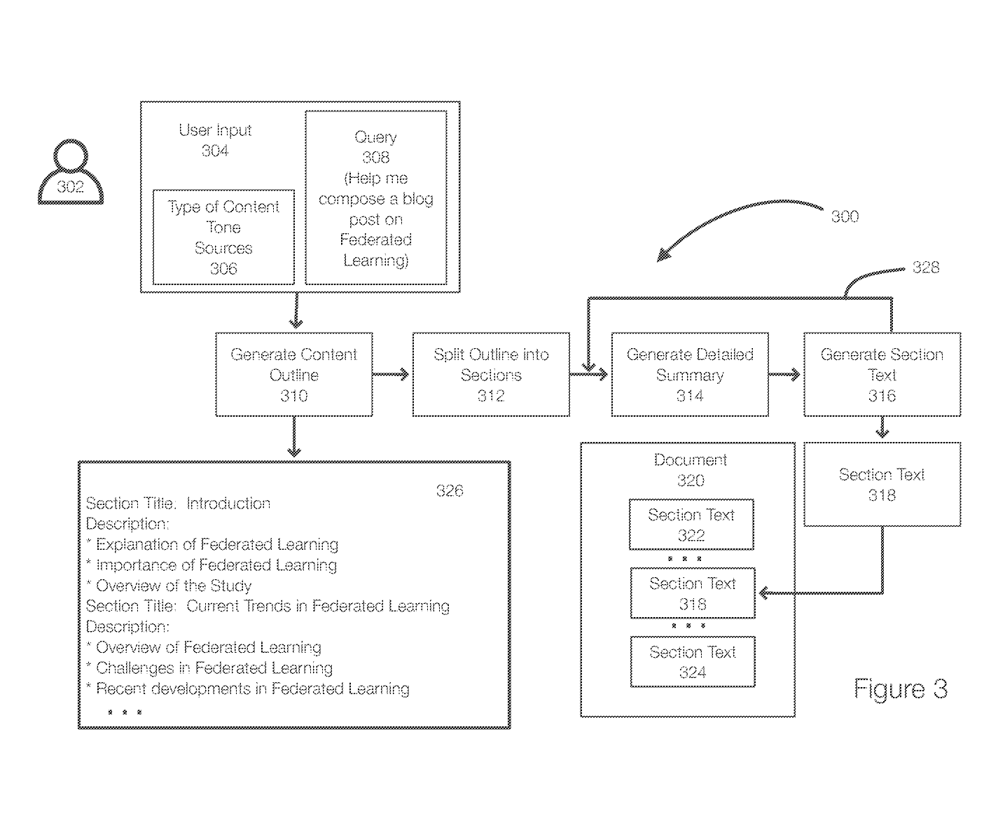

FIG. 3 discloses additional aspects of generating content such as text of a document. FIG. 3 illustrates a method 300 for generating content. In the method 300, user input 304 received from a user 302 may include a query 308 (e.g., “Help me compose a blog post on Federated Learning”). The user input 304 may also include type of content, tone, and sources 306. With the user input 304, a prompt is built and input to a draft model. The draft model may generate 310 an outline, such as the outline 326. The outline 326 may include mandatory sections and optional sections.

In one example, the sections of the outline 326 can be automatically identified at least because the prompt that includes the user input 304 may also include a template as previously described. Thus, the outline 326 is split 312 into sections. The sections of the outline 326, which is a raw form of the document 320, may include a title and a description. The title and the description may be used in a query to generate a detailed summary 314. The detailed summary 314 may be used to generate 316 the text of the section. The output is a draft of the section text 318, which may be added to the initial draft of the document 320 being generated. In this example, the loop 328 allows the text of a current section be used in generating the next section of the hierarchical outline. When completed, the sections are combined to generate the document 320, which includes section texts 322, 318, and 324.

The document 320, which may be an initial draft in this example, may be presented to a user via a user interface for modification.

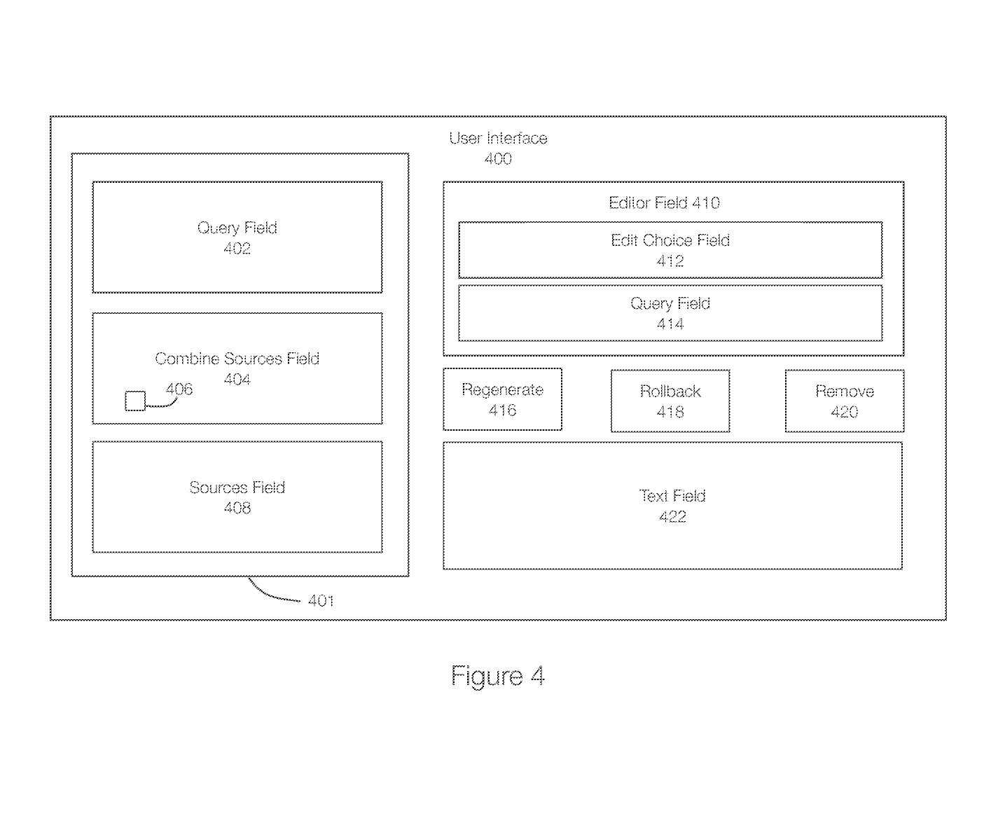

FIG. 4 discloses aspects of a user interface for generating content such as text. The interface 400 is configured to receive input from a user, interface with models, display model responses and other aspects of the content being generated, and the like. In this example a query field 402 is configured to receive a query from a user. A checkbox 406, which can be selected or deselected, allows a user to combine the online sources uploaded in the sources field 408 with other offline sources. In this example, the sources listed in the sources field 408 are uploaded or input by a user. Thus, the query input to the query field 402, the selection/deselection of the box 406 in the combine sources field 404, and the sources uploaded and identified in the sources field 408, and/or other input may be used to generate a prompt. In one example, a user may submit the input 401 and the application presenting the user interface 400 may generate a prompt. In one example, the prompt may be based on a template such that a model response is an outline.

The response is initially presented in the text field 422. In one example, the text field 222 may present an outline prior to generating the text of the sections. Alternatively, the application may present the initial draft of the document in the text field 422. In other words, the process of generating the outline and generating text for the sections, which includes source selection and source reranking, may be performed automatically when generating the initial draft.

Once the initial draft is presented in the text field 422, a user may be able to select a section and use an editor 410 to perform modifications. The edit choice 412 allows a user to select a specific section in the text field 422. The text of the section may be edited manually in the text field 422. The query field 414 allows a user to input a query that allows a section to be regenerated using a model. The query and the selected section are input to a modification model when regenerate 416 is selected. The rollback 418 allows a change to be reversed and the remove 420 allows a section to be removed.

Alternatively, the user may simply select a portion to be regenerated and the content generation system may be configured to automatically identify the section corresponding to the selected portion and the sources needed for regeneration purposes.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, content generation operations, source reranking operations, heuristic and style content generation operations, source selection operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other services may be performed on behalf of one or more clients. Some example cloud computing environments in which embodiments may be employed include Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ or ‘object’ is intended to be broad in scope. Example embodiments are applicable to any system capable of storing and handling various types of objects, in analog, digital, or other form. Synthetic documents and/or corresponding labels are examples of data or objects.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method for generating content, the method comprising: receiving input from a user at a content generation system through a user interface, the input including a query and online sources, generating an outline using a first model using the input to build a prompt to the first model, generating text for each section of the outline and presenting the texts for all of the sections as a draft document to the user in the user interface, performing modifications on the draft document to generate a next draft, wherein the modifications include regenerating a portion of the draft document identified by the user with a second model, and outputting a final document when modifications are completed that include text from each of the sections.

Embodiment 2. The method of embodiment 1, further comprising selecting a set of sources using retrieval augmented generation (RAG) from the online sources and/or offline sources available to the first model.

Embodiment 3. The method of embodiment 1 and/or 2, wherein the first model and the second model are the same model or wherein the first model is a large language model configured to generate an initial draft of the draft document and the second model is configured to regenerate sections of the draft document.

Embodiment 4. The method of embodiment 1, 2, and/or 3, wherein the set of sources are identified by a model that is more lightweight than the first model.

Embodiment 5. The method of embodiment 1, 2, 3, and/or 4, further comprising reranking the set of sources for each of the sections independently, , wherein the sources are documents or chunks.

Embodiment 6. The method of embodiment 1, 2, 3, 4, and/or 5, further comprising generating text for each of the sections based on, for each section, a top k sources of the corresponding reranked set of sources, wherein for each of the sections, the top k sources are used to generate the corresponding text.

Embodiment 7. The method of embodiment 1, 2, 3, 4, 5, and/or 6, further comprising presenting the draft document in the user interface, wherein a portion of the draft document is selected for regeneration and regenerating the portion of the draft document with the second model, wherein the second model is configured to generate small ‘fill-in-the-middle’ (FIM) type corrections.

Embodiment 8. The method of embodiment 1, 2, 3, 4, 5, 6, and/or 7, further comprising generating special parts of the draft documents based on the generated texts of the sections.

Embodiment 9. The method of embodiment 1, 2, 3, 4, 5, 6, 7, and/or 8, further comprising submitting a query for each of the sections being modified to the second model.

Embodiment 10. The method of embodiment 1, 2, 3, 4, 5, 6, 7, 8, and/or 9, wherein the set of sources is identified using RAG-based retrieval and the texts are generated using RAG-based generation.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

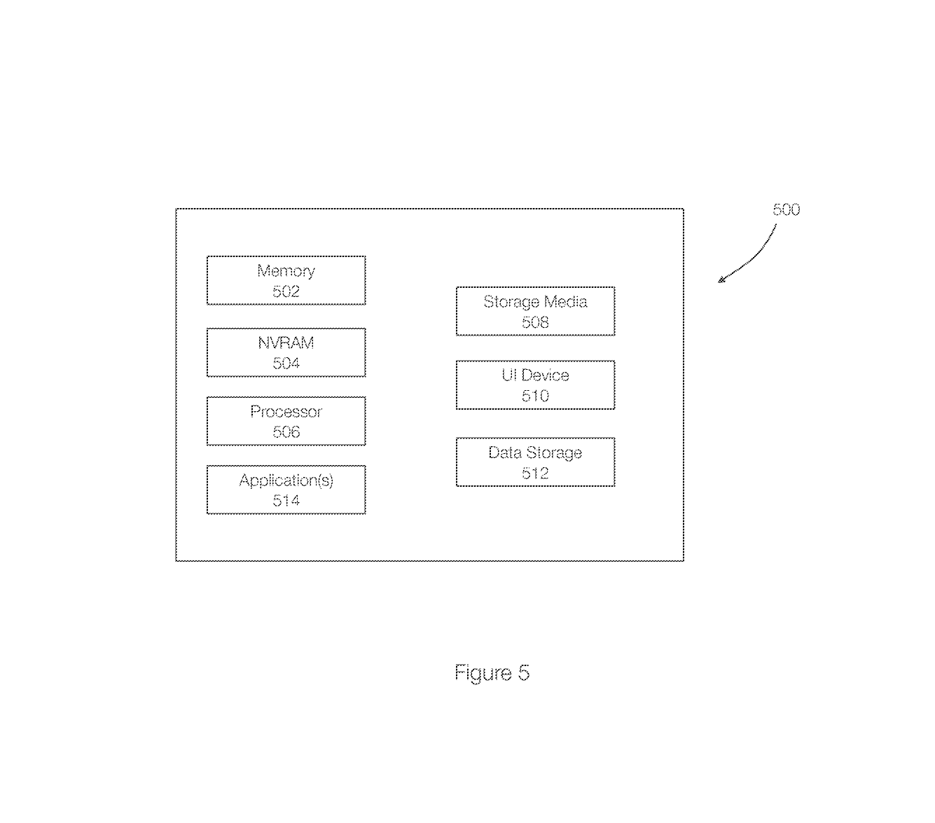

With reference briefly now to FIG. 5, any one or more of the entities disclosed, or implied, by the Figures and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

The device 500 may also represent a computing system such as a server or set of servers, an edge based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 500 may also represent a physical or virtual machine or server, an edge-based computing system, a cloud-based computing system, server clusters or other computing systems or environments. The device 500 may also represent multiple machines or devices, whether virtual, containerized, or physical. The device 500 may perform or execute steps or acts of the methods illustrated in the Figures.

The device 500 may represent a cloud-based system, an edge-based, system, an on-premise system, or combinations thereof. Document understanding and related operations may be performed using these types of computing environments/systems.

The described embodiments are to be considered in all respects only as illustrative and not restrictive. All changes which come within the meaning and range of equivalency of the claims are to be embraced within their scope.

What is claimed is:

1. A method for generating content, the method comprising:
receiving input from a user at a content generation system through a user interface, the input including a query and online sources;
generating an outline using a first model using the input to build a prompt to the first model;
generating text for each section of the outline and presenting the texts for all of the sections as a draft document to the user in the user interface;
performing modifications on the draft document to generate a next draft, wherein the modifications include regenerating a portion of the draft document identified by the user with a second model; and
outputting a final document when modifications are completed that include text from each of the sections.

2. The method of claim 1, further comprising selecting a set of sources using retrieval augmented generation (RAG) from the online sources and/or offline sources available to the first model.

3. The method of claim 1, wherein the first model and the second model are the same model or wherein the first model is a large language model configured to generate an initial draft of the draft document and the second model is configured to regenerate sections of the draft document.

4. The method of claim 1, wherein the set of sources are identified by a model that is more lightweight than the first model.

5. The method of claim 4, further comprising reranking the set of sources for each of the sections independently, wherein the sources are documents or chunks.

6. The method of claim 5, further comprising generating text for each of the sections based on, for each section, a top k sources of the corresponding reranked set of sources, wherein for each of the sections, the top k sources are used to generate the corresponding text.

7. The method of claim 1, further comprising presenting the draft document in the user interface, wherein a portion of the draft document is selected for regeneration and regenerating the portion of the draft document with the second model, wherein the second model is configured to generate small ‘fill-in-the-middle’ (FIM) type corrections.

8. The method of claim 7, further comprising generating special parts of the draft documents based on the generated texts of the sections.

9. The method of claim 8, further comprising submitting a query for each of the sections being modified to the second model.

10. The method of claim 1, wherein the set of sources is identified using RAG-based retrieval and the texts are generated using RAG-based generation.

11. A non-transitory storage medium having stored therein instructions that are executable by one or more hardware processors to perform operations for generating content, the operations comprising:
receiving input from a user at a content generation system through a user interface, the input including a query and online sources;
generating an outline using a first model using the input to build a prompt to the first model;
generating text for each section of the outline and presenting the texts for all of the sections as a draft document to the user in the user interface;
performing modifications on the draft document to generate a next draft, wherein the modifications include regenerating a portion of the draft document identified by the user with a second model; and
outputting a final document when modifications are completed that include text from each of the sections.

12. The non-transitory storage medium of claim 11, further comprising selecting a set of sources using retrieval augmented generation (RAG) from the online sources and/or offline sources available to the first model.

13. The non-transitory storage medium of claim 11, wherein the first model and the second model are the same model or wherein the first model is a large language model configured to generate an initial draft of the draft document and the second model is configured to regenerate sections of the draft document.

14. The non-transitory storage medium of claim 11, wherein the set of sources are identified by a model that is more lightweight than the first model.

15. The non-transitory storage medium of claim 14, further comprising reranking the set of sources for each of the sections independently, wherein the sources are documents or chunks.

16. The non-transitory storage medium of claim 15, further comprising generating text for each of the sections based on, for each section, a top k sources of the corresponding reranked set of sources, wherein for each of the sections, the top k sources are used to generate the corresponding text.

17. The non-transitory storage medium of claim 11, further comprising presenting the draft document in the user interface, wherein a portion of the draft document is selected for regeneration and regenerating the portion of the draft document with the second model, wherein the second model is configured to generate small ‘fill-in-the-middle’ (FIM) type corrections.

18. The non-transitory storage medium of claim 17, further comprising generating special parts of the draft documents based on the generated texts of the sections.

19. The non-transitory storage medium of claim 18, further comprising submitting a query for each of the sections being modified to the second model.

20. The non-transitory storage medium of claim 11, wherein the set of sources is identified using RAG-based retrieval and the texts are generated using RAG-based generation.
